(19) United States
(12) Patent Application Publication
(10) Pub. No.: US 2008/0142245 A1
(43) Pub. Date: Jun. 19, 2008

(54) High Temperature Cable and the Use Thereof

(75) Inventor: Thomas Cantz, Stafa (CH)

Correspondence Address: THE WEBB LAW FIRM, P.C., 700 KOPPERS BUILDING, 436 SEVENTH AVENUE, PITTSBURGH, PA, 15219, US

(73) Assignee: HUBER + SUHNER AG, PFAFFIKON (CH)

(21) Appl. No.: 11/883,858

(22) PCT Filed: Jan. 12, 2006
(86) PCT No.: PCT/CH2006/000027

§ 371 Date: Aug. 7, 2007

(30) Foreign Application Priority Data
Feb. 9, 2005 (CH) 212/05

(51) Int. Cl. H01B 7/00

(52) U.S. Cl. 174/111

(57) ABSTRACT

The invention relates to a high temperature cable comprising a plurality of electric conductors which extend in a common envelop and are remote from each other and from said envelop by means of a plurality of insulating bodies which are successively disposed in the longitudinal direction of the cable and support each other, wherein said conductors are guided in through openings embodied in the individual insulating bodies. The aim of said invention is to simplify the production of the high temperature cable and to improve the properties thereof. For this purpose, the separate insulating bodies are associated with at least two conductors and form therewith at least two separate electrically insulated threads which are twisted and stranded.

### TECHNICAL FIELD

The present invention relates to the field of electrical cables. It relates to a high temperature cable in accordance with the precharacterizing clause of claim 1 and to a use for such a high temperature cable.

### PRIOR ART

In order to control and regulate internal combustion engines, lambda probes have long been used on the exhaust side, with which lambda probes the oxygen content in the exhaust gases is measured and monitored. For this purpose, in a known manner the lambda probes are screwed into an exhaust pipe from the outside at a suitable point of the exhaust section, in particular upstream of the catalytic converter, with the result that they protrude with the measurement-sensitive sensor part into the exhaust gas flow and can be electrically connected to the motor controller from the outside. The radial installation of the lambda probe and a comparatively long probe length in the radial direction make it possible to reduce the thermal load on the connection line for the lambda probe despite the high temperatures in the vicinity of the exhaust, with the result that plastic insulation and sheathing can be used in the construction of the multi-strand connection cable (see DE-A1-196 11 572, for example). However, this presupposes that there is sufficient space available around the exhaust pipe in order to produce enough distance from the exhaust pipe in the radial direction.

Recently, increasingly less space has been available in the exhaust region owing to the installation of additional assemblies and units. It is therefore desirable to use lambda probes with a relatively short physical length and to bend the connection cable back shortly after it emerges from the lambda probe and then to guide it further, parallel to the exhaust. As a result, the connection cable is guided closer to the exhaust pipe and is subjected to correspondingly higher temperatures.

It has already been proposed in DE-A1-198 33 863 to provide, in the case of a connection cable for a lambda probe, a metallic corrugated tube as the supporting sheathing instead of a corrugated PTFE flexible tube in order to achieve improved protection against kinking and a higher capacity for thermal loading. The individually insulated conductors which are guided within the corrugated tube are in this case surrounded by a flexible filling material, which completely fills the intermediate space between the conductors and the corrugated tube. Completely filling the corrugated tube with a filling material is complex and reduces the flexibility of the connection cable.

EP-A2-0 843 321 has disclosed a connection cable for a lambda probe in which bare connection wires and ventilation pipes are arranged in a common tubular sleeve consisting of stainless steel such that they are fixed and separated from one another by means of an insulating powder filling. In this case, too, manufacture is complex and flexibility is low. In addition, owing to the powder filling, contact between the wires and the tubular sleeve in the case of severe vibrations occurring during operation cannot permanently be ruled out.

Finally, DE-A1-102 40 238 has proposed a connection line for a sensor probe, in particular a lambda probe, in which a plurality of bare conductors in a metallic tubular sheath are insulated from one another and from the tubular sheath by insulating means, which comprise a large number of insulating bodies, which are arranged in series, are supported against one another and each have a plurality of through-holes for the conductors. The ceramic insulating bodies act in the same way as the individual vertebrae of a spinal column and are shaped specially in order to achieve the desired flexibility of the connection line. Mechanical stabilization of the series of insulating bodies is achieved by an additional spring rod passing through all of the insulating bodies, which spring rod is guided through special through-holes in the insulating bodies. This type of cable construction is extremely complex both in terms of production and in terms of assembly owing to the special and precise shaping of the insulating bodies, owing to the fact that all of the conductors are guided through the same insulating bodies, and owing to the additional stabilization measures. Furthermore, only restricted flexibility is achieved. It is also known (U.S. Pat. No. 2,931,852) to provide such interengaging insulating bodies with very complex shaping in individual conductors.

### DESCRIPTION OF THE INVENTION

The object of the invention is therefore to provide a high temperature cable, in particular for use as a connection cable for a lambda probe, which avoids the disadvantages of known cables and is characterized in particular by a simple and functionally reliable construction, is easy to produce, withstands very high temperatures of up to 600° C. and is characterized by a high degree of flexibility and a high resistance to mechanical, primarily vibration loads.

The object is achieved by the entirety of the features of claim 1. The essence of the invention consists in separate insulating bodies being assigned to at least two conductors, which insulating bodies form, together with the conductors, at least two separate, electrically insulated strands, and in twisting or braiding these at least two separate, electrically insulated strands with one another within the sleeve. Owing to the twisting or braiding, on the one hand mutual fixing of the conductors is achieved which results in a lack of sensitivity to vibrations. On the other hand, the twisted or braided bundle of strands retains a high degree of flexibility. The fixing and movability are in this case largely independent of the external shape of the insulating bodies, with the result that few requirements are placed on the precision of the insulating bodies. Since the insulating bodies only need to be threaded in each case onto one conductor, considerable simplification in the production of the cable results.

Particularly favorable conditions result with respect to the movability and fixing if the insulating bodies are in the form of rings or beads with a central through-opening and are threaded onto in each case one of the at least two conductors, if the insulating bodies have a rounded portion on their outer circumferential surface, and if the insulating bodies have a rounded portion at the ends of the through-opening, in each case on the inner circumferential surface.

A long life even in the case of severe mechanical and thermal loads can be achieved by virtue of the fact that the insulating bodies comprise a material which is resistant to high temperatures and have a smooth surface, in order to reduce the friction of the insulating bodies with respect to one another and/or with respect to the conductors. It has proven particularly successful if the insulating bodies comprise glass or a glazed material, such as porcelain or glazed ceramic, for example, or another low-friction and sufficiently temperature-resistant material. In this case, the insulating bodies may have different colors in the sense of a color coding of the strands.

The conductors are preferably in the form of Cu wires or braided wires, and the sleeve is in the form of a tubular sheath, preferably in the form of a metallic corrugated tube. Owing to the corrugated tube, good flexibility of the cable with, at the same time, a high level of protection on the outside is achieved.

It may furthermore be advantageous if the high temperature cable merges with a second cable at a transition point, the conductors being designed to be continuous at the transition point, the insulating bodies in the strands being detached in each case by means of a continuous insulating sheath, and the sleeve being detached by means of a cable sheath.

According to the invention, the high temperature cable is used as a connection cable for a measuring probe which is subjected to high temperatures, in particular a lambda probe.

### BRIEF EXPLANATION OF THE FIGURES

The invention will be explained in more detail below with reference to exemplary embodiments in connection with the drawing, in which:

FIG. 1 shows the side view of an exemplary configuration of a lambda probe introduced into an exhaust pipe and having a short construction, with a bent-back connection cable;

FIG. 2 shows the plan view of (FIG. 2a) and the cross section through (FIG. 2b) a bead-shaped or annular insulating body, as is preferably used in the invention;

FIG. 3 shows four conductors with threaded-on insulating bodies of the type illustrated in FIG. 2, which are braided or twisted with one another in the form of strands so as to form a high temperature cable in accordance with one exemplary embodiment of the invention;

FIG. 4 shows the strands from FIG. 3 which have been braided or twisted with one another so as to form a bundle, the insulating bodies of the individual strands only being indicated at certain points;

FIG. 5 shows the arrangement of the braided or twisted strands in a corrugated tube;

FIG. 6 shows, in an illustration comparable to that in FIG. 5, the continuous transition between a cable section, which, in accordance with the invention, is in the form of a high temperature cable, and an adjoining cable section with a conventional configuration; and

FIG. 7 shows a photograph of a prototype of the high temperature cable according to the invention.

### APPROACHES FOR IMPLEMENTING THE INVENTION

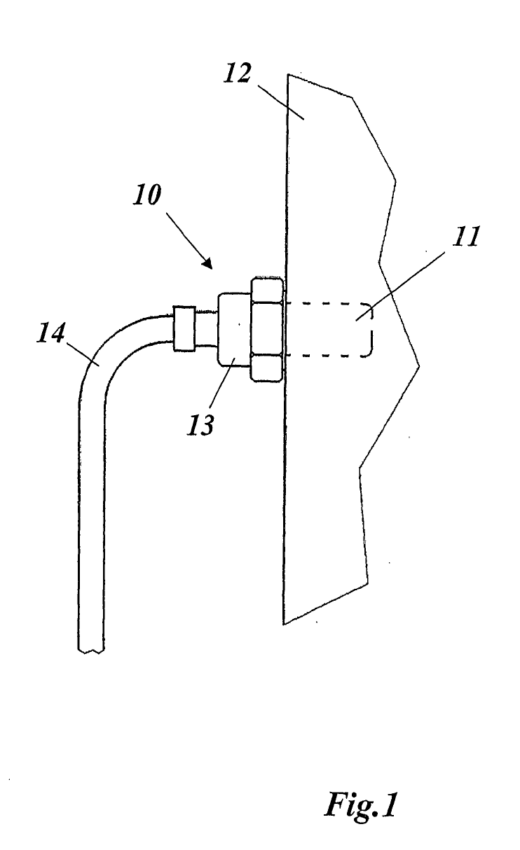

FIG. 1 illustrates, in the side view, an exemplary configuration of a lambda probe installed in an exhaust pipe and having a short construction with a bent-back connection cable. The lambda probe 10 is screwed into a corresponding threaded hole in an exhaust pipe 12 in the radial direction and protrudes with a measuring head 11 (illustrated by dashed lines) into the exhaust gas flow guided in the exhaust pipe 12. The lambda probe 10 protrudes with its housing 13 out of the exhaust pipe 12. At the outer end of the housing 13, a connection cable 14, which is connected fixedly to the probe, emerges from the housing 13, which connection cable 14 is bent back at right angles downstream of the point at which it emerges and is guided further, approximately parallel to the exhaust pipe 12. Usually four or five individual conductors, which connect the measuring element of the lambda probe 10 to a motor controller (not illustrated), run, electrically insulated, within the connection cable 14. Owing to the short physical length of the lambda probe 10 and the fact that the connection cable 14 is guided to the exhaust pipe 12, the connection cable 14 is subjected to temperatures of up to approximately 600° C. For this reason, a high temperature cable needs to be used as the connection cable 14.

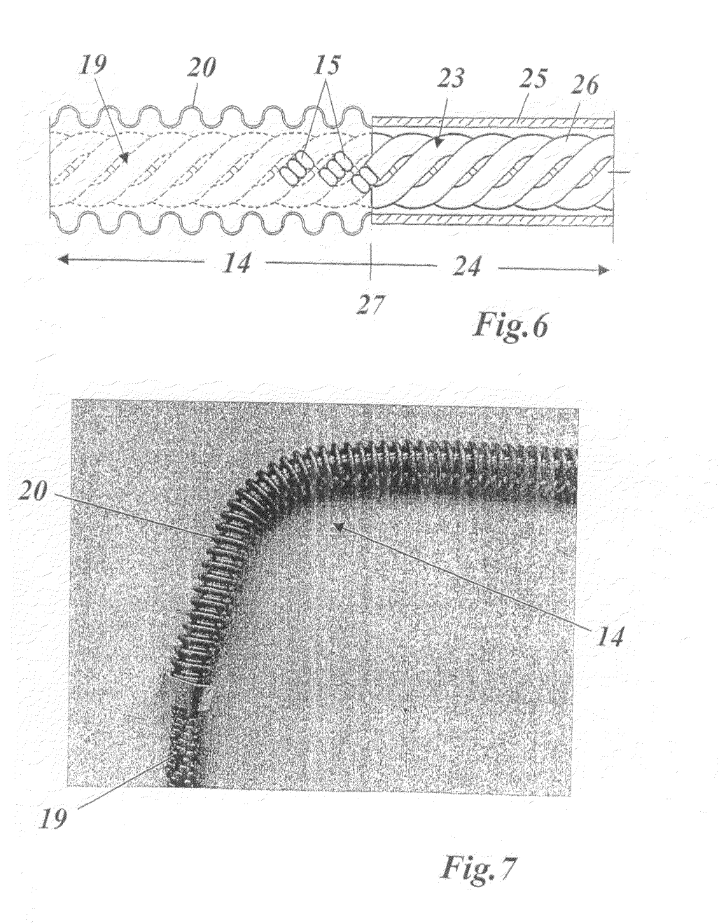

An exemplary embodiment of such a connection cable 14 in the form of a high temperature cable is reproduced photographically in FIG. 6. The connection cable 14 comprises an external metallic corrugated tube 20 (with a helical corrugation), in which a bundle of strands 19 comprising four strands twisted or braided with one another is guided. Other numbers of strands are naturally also possible.

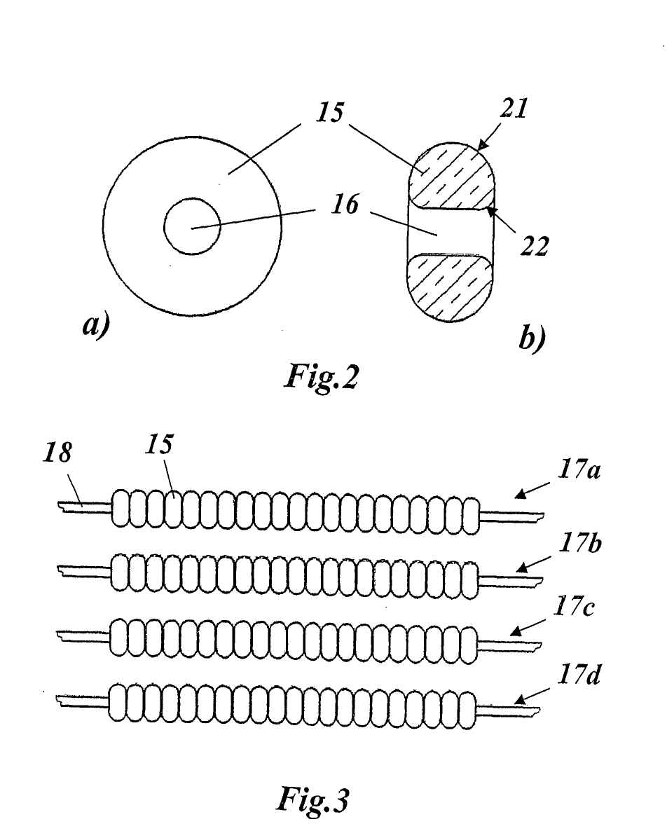

The construction of the strands or of the bundle of strands 19 will be explained in more detail below with reference to FIGS. 2 to 5. In order to construct a four-strand bundle of strands 19, four individual conductors 18 are used as the basis, as shown in FIG. 3; the conductors 18 may be in the form of Cu wires or Cu braided wires, for example, and have a cross section which is suitable for the application. The conductors 18 may naturally also comprise other metals or metal alloys. As shown in FIG. 3, electrically insulated strands 17a, . . . , d are produced from the individual conductors 18 by a large number of preferably identical insulating bodies 15 being threaded onto each conductor, which insulating bodies 15 are arranged in series in the longitudinal direction and are supported on one another and form a type of “string of beads”. Since the connection line 14 of a lambda probe 10 has approximately a length of 200 mm, a sufficiently large number of insulating bodies 15 need to be threaded on in order to insulate the conductors 18 from the outside over such a length.

Preferably, an annular or bead-shaped body is used as the insulating body 15, as is illustrated by way of example in FIG. 2. The insulating body 15 has a central through-opening 16, through which the conductor 18 is threaded when forming the strands 17a, . . . , d. The inner diameter of the through-opening 16 is selected in relation to the outer diameter of the conductor 18 such that sufficient play results and the insulating body 15 on the conductor 18 is movable and can be tipped slightly. As a result, when braiding or twisting the strands 17a, . . . , d, it is necessary to match the strands to one another and uniformity of the bundle of strands 19 is achieved. Flexibility of the cable is also required since the individual insulating bodies 15 are more capable of moving in relation to one another. A further improvement in this regard can be achieved by virtue of the fact that the insulating bodies 15 have a first rounded portion 21 on their outer circumferential surface and have a second rounded portion 22 at the ends of the through-opening 16 in each case on the inner circumferential surface (FIG. 2b). The rounded portions 21, 22 have a radius of curvature which is large enough to make it possible for the insulating bodies 15 to roll against one another and/or on the conductors 18. In the example in FIG. 2, the first rounded portions 21 extend in the form of a semicircle over the entire length of the insulating body 15. The insulating bodies 15 preferably comprise a material which is resistant to high temperatures and have a smooth surface, by means of which the friction is reduced in the event of a relative movement with respect to other insulating bodies. Preferably, the insulating bodies 15 comprise glass or a glazed material, such as a porcelain or glazed ceramic, for example; but other materials with a low-friction surface finish are also conceivable. Excellent results can be achieved even with simple glass beads, as are used for producing necklaces. Such glass beads have outer diameters of 2-3 mm, an inner diameter of the through-opening of approximately 1 mm and a thickness of approximately 2 mm.

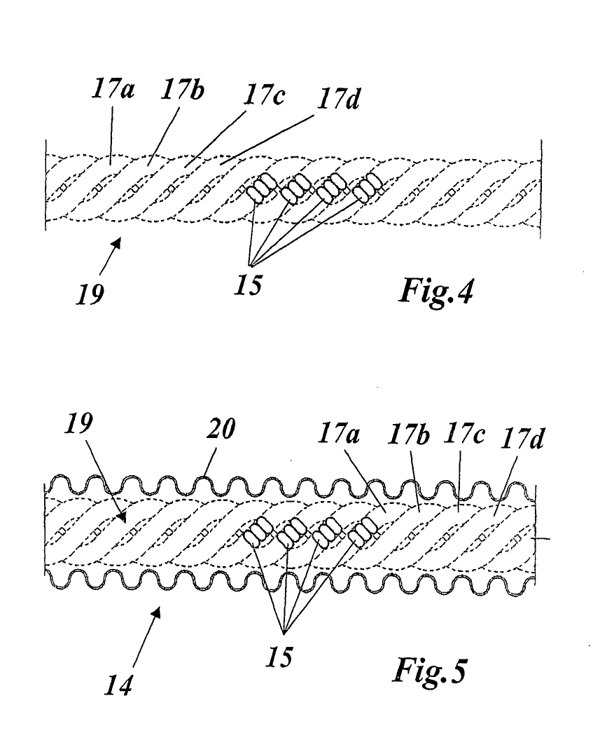

If a plurality of strands 17a, . . . , d of the type illustrated in FIG. 3 are produced, these strands are twisted or braided with one another so as to form a bundle of strands 19, as is indicated in FIG. 4 (the outer contours of the strands 17a, . . . , d are illustrated by dashed lines; individual, exemplary insulating bodies 15 in the strands are illustrated by continuous lines). For the braiding, the various braiding methods known from braiding technology can be used. It is therefore conceivable, for example, to provide a central core in addition to the strands 17a, . . . , d, around which central core the strands 17a, . . . , d are braided. Owing to the braiding or twisting, on the one hand fixing of the strands in the bundle of strands 19 is achieved which prevents the insulating bodies 15 from sliding. On the other hand, improved flexibility of the bundle of strands 19 results.

Once, as shown in FIG. 4, the bundle of strands 19 has been formed, it can be inserted into a correspondingly dimensioned corrugated tube 20 (FIG. 5). The corrugated tube 20 protects the bundle of strands 19 from mechanical and other environmental influences and limits the bending of the connection cable 14 to uncritical values of the bending radius. The clear inner diameter of the corrugated tube 20 is expediently selected such that only a low degree of freedom of movement or no degree of freedom of movement at all results within the corrugated tube 20 for the bundle of strands 19. Possible intermediate spaces between the bundle of strands 19 and the corrugated tube 20 can also be filled with an insulating material in powder form which is resistant to high temperatures, if required. Fixing of the connection cable 14 to the lambda probe 10 can take place in a similar manner to that disclosed in DE-A1-198 33 863, in which the end of the corrugated tube 20 is welded to the housing 13 of the lambda probe 10. Corresponding guide and insulating bodies can be provided at the other end of the cable for the free ends of the conductors 18, which guide and insulating bodies terminate the corrugated tube 20 and fix the conductors 18 within the scope of the connection standard used.

A further possibility consists in guiding the connection cable 14 further, outside of the high temperature region around the lambda probe 10 as a normal cable 24, as is indicated in FIG. 6. In this case, a cable 24 is used as the basis which has a normal temperature resistance and, within a cable sheath 25 comprising plastic, contains a braided or twisted bundle of strands 23 comprising strands which are provided with a conventional insulating sheath 26 comprising plastic. The cable sheath 25 and the insulating sheath 26 of the individual strands are then removed over a predetermined length up to a transition point 27, the exposed conductors 18 are then insulated by the insulating bodies 15 being threaded on and twisted further and finally inserted into the corrugated tube 20, which reaches as far as the transition point 27. At the transition point 27, the conductors 18 are therefore guided further, without any interruption, while the insulation of the conductors 18 from the insulating sheath 26 to the insulating bodies 15 and the cable sheath 25 merges with the corrugated tube 20 (for example so as to overlap it). In this way, complex and faulty connection measures between the high temperature cable and the onwardly leading cable can be avoided.

It is furthermore conceivable to use insulating bodies 15 of different colors for each of the strands 17a, . . . , d in order to produce strands of different colors which, in the form of a color coding, make it possible to quickly identify the respective conductor.

In the context of the invention, it is also conceivable, for braiding or twisting purposes, to combine strands which contain individual conductors with strands in which a plurality of conductors are threaded, spaced apart from one another, through the same insulating body, if corresponding insulating bodies with a plurality of through-openings are used. In this way, a different number of conductors can be accommodated in the cable given the same number of strands.

It is naturally possible also to use the high temperature cable according to the invention in another application apart from in automobiles where it is necessary to withstand high temperatures and other more difficult environmental conditions. Examples of these applications are heaters, furnaces, gas turbines or the like.

### LIST OF REFERENCE SYMBOLS

| | |
|---|---|
| 10 | Lambda probe |
| 11 | Measuring head |
| 12 | Exhaust pipe |
| 13 | Housing (lambda probe) |
| 14 | Connection cable (high temperature cable) |
| 15 | Insulating body (annular, bead-shaped) |
| 16 | Through-opening |
| 17a, . . . ,d | Strands |
| 18 | Conductor |
| 19, 23 | Bundle of strands |
| 20 | Corrugated tube (sleeve) |
| 21, 22 | Rounded portion |
| 24 | Cable |
| 25 | Cable sheath |
| 26 | Insulating sheath |
| 27 | Transition point |

1-10. (canceled)

11. A high temperature cable, comprising a plurality of electrical conductors, which run in a common sleeve and are held at a distance from one another and from the sleeve by means of a large number of insulating bodies, which are arranged in series so as to support one another in the longitudinal direction of the cable, the conductors being guided through through-openings in the individual insulating bodies, wherein separate insulating bodies are assigned to at least two conductors and form, together with the conductors, at least two separate, electrically insulated strands, and in that the at least two separate, electrically insulated strands are twisted or braided with one another within the sleeve.

12. The high temperature cable as claimed in claim 11, wherein the insulating bodies are in the form of rings or beads with a central through-opening and are threaded onto in each case one of the at least two conductors.

13. The high temperature cable as claimed in claim 12, wherein the insulating bodies have a rounded portion on their outer circumferential surface.

14. The high temperature cable as claimed in claim 12, wherein the insulating bodies have a rounded portion at the ends of the through-opening, in each case on the inner circumferential surface.

15. The high temperature cable as claimed in claim 11, wherein the insulating bodies comprise a material which is resistant to high temperatures and have a smooth surface.

16. The high temperature cable as claimed in claim 15, wherein the insulating bodies comprise glass or a glazed material.

17. The high temperature cable as claimed claim 11, wherein the conductors are in the form of copper wires or braided wires, and in that the sleeve is in the form of a tubular sheath, in particular in the form of a metallic corrugated tube.

18. The high temperature cable as claimed in claim 11, wherein the insulating bodies have different colors in the sense of a color coding of the strands.

19. The high temperature cable as claimed in claim 11, wherein the high temperature cable merges with a second cable at a transition point, the conductors being designed to be continuous at the transition point, the insulating bodies in the strands being detached in each case by means of a continuous insulating sheath, and the sleeve being detached by means of a cable sheath.

20. The use of a high temperature cable as claimed in claim 11, as a connection cable for a measuring probe which is subjected to high temperatures, in particular a lambda probe.
